(19) United States
(12) Patent Application Publication
(10) Pub. No.: US 2026/0010112 A1
(43) Pub. Date: Jan. 8, 2026

(54) APPARATUS STRUCTURE AND IMAGE FORMING APPARATUS

(71) Applicant: Junichi Murano, Kanagawa (JP)

(72) Inventor: Junichi Murano, Kanagawa (JP)

(73) Assignee: Ricoh Company, Ltd., Tokyo (JP)

(21) Appl. No.: 19/238,405

(22) Filed: Jun. 14, 2025

(30) Foreign Application Priority Data
Jul. 3, 2024 (JP) 2024-107763

(51) Int. Cl. G03G 21/16

(52) U.S. Cl. CPC G03G 21/1619; G03G 2221/1651; G03G 2221/1678

(57) ABSTRACT

An apparatus structure includes a pair of side plates facing each other, and a stay fastened to the pair of side plates with a first screw and a second screw. One of the pair of side plates and a first stay portion of the stay has a first screw hole through which the first screw is inserted. The other has a first internal thread into which the first screw is threaded. One of the pair of side plates or a second stay portion of the stay has a second screw hole through which the second screw is inserted. The other has a second internal thread into which the second screw is threaded. One of the first screw hole or the second screw hole is larger than the other.

### CROSS-REFERENCE TO RELATED APPLICATIONS

This patent application is based on and claims priority pursuant to 35 U.S.C. § 119 (a) to Japanese Patent Application No. 2024-107763, filed on Jul. 3, 2024, in the Japan Patent Office, the entire disclosure of which is hereby incorporated by reference herein.

### BACKGROUND

### Technical Field

The present disclosure relates to an apparatus structure and an image forming apparatus.

### Related Art

An apparatus structure is known that includes a pair of opposing side plates and a stay fastened to the side plates with screws to connect the side plates. The stay includes a first stay portion and a second stay portion bent relative to the first stay portion.

### SUMMARY

An embodiment of the present disclosure provides an apparatus structure including a pair of side plates facing each other in a facing direction; and a stay fastened to the pair of side plates with a first screw and a second screw to connect the pair of side plates, the stay including a first stay portion; and a second stay portion bent relative to the first stay portion. One of the pair of side plates. The first stay portion has a first screw hole through which the first screw is inserted. The other of the pair of side plates or the first stay portion has a first internal thread into which the first screw is threaded to fasten the first stay portion to the pair of side plates with the first screw. One of the pair of side plates or the second stay portion having a second screw hole through which the second screw is inserted. The other of the pair of side plates or the second stay portion having a second internal thread into which the second screw is threaded to fasten the second stay portion to the pair of side plates with the second screw. One of the first screw hole or the second screw hole is larger than the other of the first screw hole or the second screw hole.

An embodiment of the present disclosure provides an apparatus structure including a pair of side plates facing each other in a facing direction; and a stay fastened to the pair of side plates with a first screw and a second screw to connect the pair of side plates, the stay including a first stay portion; and a second stay portion bent relative to the first stay portion. The pair of side plates has a first screw hole through which the first screw is inserted. The first stay portion has a first internal thread into which the first screw is threaded to fasten the first stay portion to the pair of side plates with the first screw. The pair of side plates has a second screw hole through which the second screw is inserted. The second stay portion has a second internal thread into which the second screw is threaded to fasten the second stay portion to the pair of side plates with the second screw. One of the first screw hole or the second screw hole is larger than the other of the first screw hole or the second screw hole.

An embodiment of the present disclosure provides an apparatus structure including a pair of side plates facing each other in a facing direction; and a stay fastened to the pair of side plates with a first screw and a second screw to connect the pair of side plates, the stay including a first stay portion; and a second stay portion bent relative to the first stay portion. The first stay portion has a first screw hole through which the first screw is inserted. The pair of side plates has a first internal thread into which the first screw is threaded to fasten the first stay portion to the pair of side plates with the first screw. The second stay portion has a second screw hole through which the second screw is inserted. The pair of side plates has a second internal thread into which the second screw is threaded to fasten the second stay portion to the pair of side plates with the second screw. One of the first screw hole or the second screw hole is larger than the other of the first screw hole or the second screw hole.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a color image forming apparatus according an embodiment of the present disclosure;

FIG. 2 is a perspective view of a body frame of the image forming apparatus in FIG. 1, viewed obliquely from below;

FIG. 3 is a perspective view of the body frame in FIG. 2, viewed from an angle different from that in FIG. 2.

FIGS. 4A and 4B are diagrams each illustrating a configuration according to a comparative example, with aspects to be improved;

FIGS. 5A and 5B are diagrams each illustrating screw holes in a side plate to which a second stay is fastened, according to an embodiment of the present disclosure; and

FIG. 6 is a diagram illustrating screw holes in a side plate according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A typical apparatus structure includes a stay having a substantially horizontal, plate-like first stay portion. The ends of this portion, extending in a direction orthogonal to the opposing direction of a pair of side plates, are bent upward by approximately 90 degrees to form second stay portions. It is described that the second stay portions formed by bending the ends of the first stay portion increase the bending stiffness of the stay and allow the pair of side plates to be firmly connected.

However, such a configuration with the first stay portion and the second stay portion respectively fastened to the side plates with screws might cause distortion in the apparatus structure itself.

According to one aspect of the present disclosure, the distortion of the apparatus structure can be prevented.

Some embodiments of the present disclosure are described below with reference to the drawings.

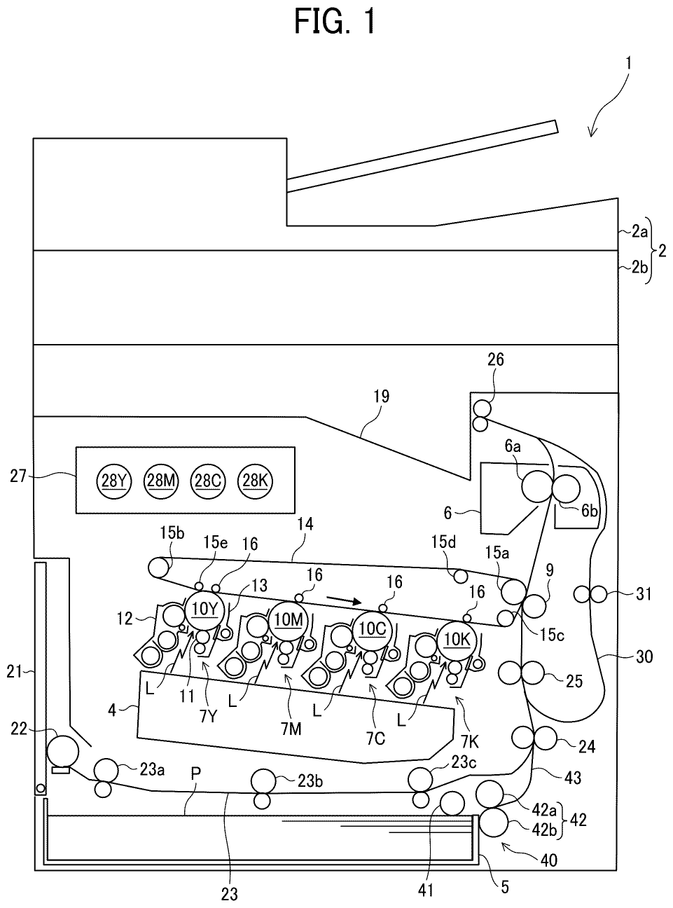

A color image forming apparatus 1 according to an embodiment of the present disclosure is first described with reference to FIG. 1.

FIG. 1 is a schematic diagram illustrating the configuration of the color image forming apparatus 1. In the following description, the color image forming apparatus is referred to as the image forming apparatus 1.

As illustrated in FIG. 1, the image forming apparatus 1 is a full-color image forming device that includes four drum-shaped photoconductors 10Y, 10C, 10M, and 10K arranged in tandem as latent image carriers. These photoconductors 10Y, 10C, 10M, and 10K are configured as parts of respective image-forming units 7Y, 7C, 7M, and 7K, which serve as image formers. The image-forming units 7Y, 7C, 7M, and 7K correspond to yellow, cyan, magenta, and black, respectively, and form images in these respective colors.

The image forming apparatus 1 of FIG. 1 includes an intermediate transfer belt 14 as a surface-moving member that is supported by five support rollers 15a, 15b, 15c, 15d, and 15c and rotates. Along the lower stretched line of the intermediate transfer belt 14, the image-forming units 7Y, 7C, 7M, and 7K are sequentially arranged at intervals from the upstream side in the moving direction of the intermediate transfer belt 14 indicated by the arrow.

In the formation of a full-color image, toner images of respective colors are formed on the photoconductors 10Y, 10C, 10M, and 10K in the image-forming units 7Y, 7C, 7M, and 7K. Subsequently, as the intermediate transfer belt 14 is moved by the function of the multiple primary transfer rollers 16, the toner images of those different colors are sequentially transferred onto the intermediate transfer belt 14 by superimposing multiple images on top of one another. The multiple primary transfer rollers 16 serve as transferors arranged to face the multiple photoconductors 10Y, 10C, 10M, and 10K with the intermediate transfer belt 14 interposed therebetween. Specifically, portions of the intermediate transfer belt 14 in contact with the primary transfer rollers 16 are referred to as transfer positions, where the transfer is performed.

The four layered toner images are collectively transferred onto a sheet P at a nip between the support roller 15a and a secondary transfer roller 9. As the sheet P passes through the fixing rollers 6a and 6b of a fixing device 6, the toner images are fixed onto the sheet P. The sheet is output to a sheet tray 19 by discharge rollers 26. As a result, a full-color image is formed on the sheet P.

The intermediate transfer belt 14 remains in constant contact with the photoconductor 10K via the primary transfer rollers 16 to accommodate the single black image formation mode, whereas for the other photoconductors 10Y, 10C, and 10M, the intermediate transfer belt 14 can be engaged or disengaged by a movable tension roller.

Below the main body of the image forming apparatus, a sheet feed cassette 5 holds multiple sheets P, used for recording output images, and a sheet feeder 40 supplies these sheets. The sheet feeder 40 includes a pickup roller 41 that can engage and disengage with the sheets stacked in the sheet feed cassette 5, and a separation roller pair 42 that separates multiple sheets fed by the pickup roller 41 and feeds only the top sheet. The separation roller pair 42 includes a feed roller 42a and a reverse roller 42b. The feed roller 42a is rotationally driven by the driving force transmitted from a drive motor to be described later, causing its surface to move in the sheet feeding direction at the separation nip of the separation roller pair 42. The reverse roller 42b is also rotationally driven via a torque limiter by the driving force transmitted from the drive motor, causing its surface to move in a direction that returns the sheet P to the sheet feed cassette 5 at the separation nip.

The rotational load on the reverse roller 42b is relatively high when either a single sheet or no sheet is held in the separation nip. As such, the torque applied to the reverse roller 42b becomes equal to or greater than a specified value, causing the torque limiter to disconnect the drive from the motor. As a result, the reverse roller 42b idles and rotates along with the feed roller 42a.

When multiple sheets are held in the separation nip, the slippage between the sheets results in a relatively low rotational load on the reverse roller 42b. Consequently, the torque on the reverse roller 42b falls below the specified value, allowing the torque limiter to transmit the driving force from the motor to the reverse roller 42b. As a result, the reverse roller 42b, driven by the motor, rotates in the direction that moves the sheets back toward the sheet feed cassette 5 at the separation nip. This causes the lower sheets, except for the topmost one among those held in the separation nip, to be returned to the sheet feed cassette 5.

Sheets that have passed through the separation nip are conveyed by relay conveyance rollers 24 along a sheet feeding path 43 to registration rollers 25.

On the left side of the image forming apparatus 1 in FIG. 1, a manual feed tray 21 for manual sheet feeding is placed. Between a writing device 4, which serves as a latent image writer or a detachable component, and the sheet feed cassette 5, a manual relay conveyance path 23 as a manual conveyance path is disposed. This path conveys the sheets P fed from the manual feed tray 21 to the junction with a sheet feeding path 43, using a manual sheet feed roller 22. Along or on the manual relay conveyance path 23, three manual relay conveyance rollers 23a, 23b, and 23c are disposed. The manual relay conveyance path 23 merges with the sheet feeding path 43 just before the relay conveyance rollers 24.

To the right of the fixing device 6 in the image forming apparatus 1, an inversion conveyance path 30 for conveying sheets P back to a secondary transfer nip during duplex printing is placed. The inversion conveyance path 30 includes inversion conveyance rollers 31.

Additionally, the image forming apparatus 1 may be equipped with an image reader 2 that includes a scanner 2b and an automatic document feeder (ADF) 2a on its top. The ADF 2a feeds out documents, which are sheets set by the user for image reading, and the scanner 2b reads the images of the documents fed from the ADF 2a.

In FIG. 1, the image-forming units 7Y, 7C, 7M, and 7K differ only in toner color; their mechanical structure and image-forming processes are the same. As such, components other than the photoconductors share like reference numbers, and the structure and image formation process are described using one unit, such as image-forming unit 7Y, as an example.

Around the photoconductor 10Y of the image-forming unit 7Y, the following components are arranged in a clockwise direction: a charging roller 11, which serves as a charger for charging the photoconductor 10Y, the exposure position of a light beam L, a developing device 12, a primary transfer roller 16, and a cleaning device 13.

The light beam L is emitted from the writing device 4. The writing device 4 includes a semiconductor laser that serves as a light source, a coupling lens, an fθ lens, a toroidal lens, a mirror, a rotating polygon mirror. The writing device 4 emits light beams L for the respective colors to the photoconductors, and irradiates a writing position on the photoconductor 10Y with the light beam L to form an electrostatic latent image.

For example, in the developing device 12 of the image-forming unit 7Y, a yellow developer is stored, and a latent image is visualized as a yellow image. The other image-forming units also store developers of respective colors, and a latent image is visualized in its corresponding color of the developer stored in each unit.

During image formation, the photoconductor 10Y rotates and is uniformly charged by the charging roller 11. The photoconductor 10Y is then exposed to the light beam L containing yellow image information at the writing position, resulting in formation of an electrostatic latent image on the surface of the photoconductor 10Y. This latent image is developed into a visible image (i.e., a yellow toner image) using yellow toner during its passage through the developing device 12.

The yellow toner image on the photoconductor 10Y is transferred to the intermediate transfer belt 14 by the primary transfer roller 16. The yellow toner image on the intermediate transfer belt 14 is sequentially overlaid with a cyan toner image in the image-forming unit 7C, a magenta toner image in the image-forming unit 7M, and a black toner image in the image-forming unit 7K. This process creates a full-color toner image.

After transfer, the residual toner on the photoconductor 10Y is removed by the cleaning device 13 and then discharged by a discharge lamp in preparation for the next image formation.

The sheet P is fed from either the sheet feed cassette 5 or the manual feed tray 21 and stops temporarily when reaching the registration roller 25. At a predetermined timing, the registration roller 25 rotates to feed the sheet P toward the nip between the support roller 15a and the secondary transfer roller 9.

The full-color toner image overlaid on the intermediate transfer belt 14 is secondarily transferred onto the sheet P at the nip between the support roller 15a and the secondary transfer roller 9. The sheet P, onto which the full-color toner image has been transferred, is conveyed to the fixing device 6 and passes through the fixing nip. The toner image on the sheet P is heated and fixed by the heat from the fixing roller 6a at the fixing nip. For single-sided printing, the sheet P with the fixed toner image is discharged outside the apparatus by the discharge rollers 26. For double-sided printing, the sheet P is switched back by the discharge rollers 26, conveyed to the reverse conveyance path 30, and turned over so that its reverse side faces upward. An image is formed on the reverse side, as described above, before being discharged outside the apparatus.

A bottle container 27 is disposed between the intermediate transfer belt 14 and the sheet tray 19 located above the intermediate transfer belt 14. The bottle container 27 contains toner bottles 28Y, 28M, 28C, and 28K, which serve as toner supply containers for yellow (Y), magenta (M), cyan (C), and black (K) toners, respectively. The toner bottles 28Y, 28M, 28C, and 28K are placed on the bottle container 27 from above for each color of toner. The yellow (Y), magenta (M), cyan (C), and black (K) toners in the toner bottles 28Y, 28M, 28C, and 28K are appropriately supplied to the developing devices 12 of the image-forming units 7Y, M, C, and K by toner supply devices, respectively. The toner bottles 28Y, 28M, 28C, and 28K are detachably attachable to the body of the image forming apparatus independently of the image-forming units 7Y, 7M, 7C, and 7K.

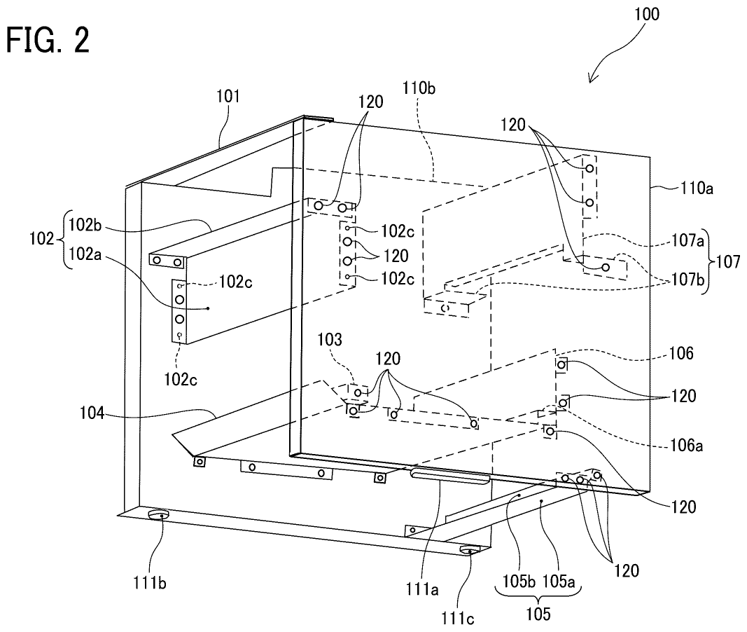

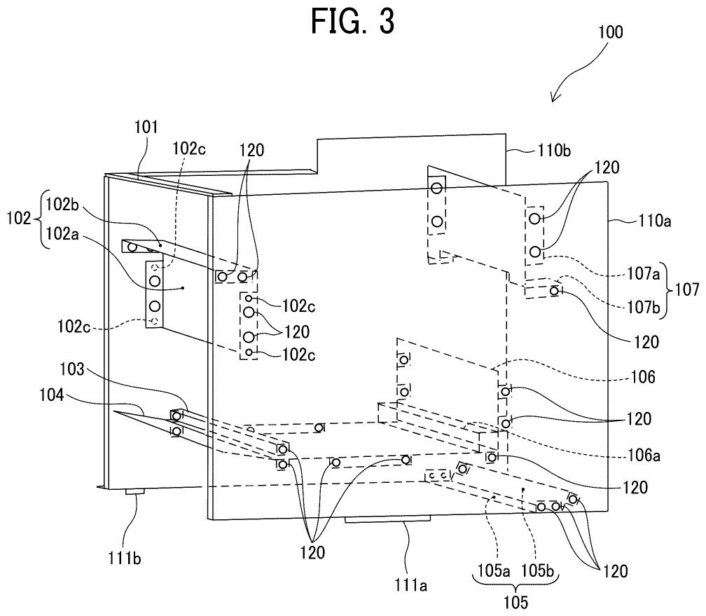

FIG. 2 is a perspective view of a body frame 100, which is the structural body of the image forming apparatus 1, viewed obliquely from below. The body frame 100 is an example of the structure of the apparatus, which is referred to as an apparatus structure. FIG. 3 is a perspective view of the body frame 100 from an angle different from that of FIG. 2.

As illustrated in FIGS. 2 and 3, the body frame 100 includes a pair of side plates 110a and 110b and seven first to seventh first to seventh stays 101 to 107, which are fastened to the pair of side plates 110a and 110b with screws 120 to connect the side plates together. The pair of side plates 110a and 110b and the first to seventh stays 101 to 107 are made of metal plates and are shaped into predetermined forms by bending, for example, through press working.

A rubber foot 111a is placed at the center of the bottom of the first side plate 110a on the front side in FIG. 2. Rubber feet 111b and 111c are placed at both ends of the bottom of a second side plate 110b on the back side in FIG. 2. The rubber feet 111a, 111b, and 111c serve as support portions. In this case, “both ends” refers to the ends of the bottom of the second side plate 110b in the horizontal direction. The body frame 100 is supported at three points by the rubber feet 111a, 111b, and 111c, and rests on the installation surface on which the image forming apparatus 1 is placed.

The first stay 101 is screwed to the left ends of the upper portions of the pair of side plates 110a and 110b in FIG. 2. The “left ends” indicate the side where the manual feed tray 21 is located. The second stay 102 is screwed to the left side of the pair of side plates 110a and 110b in FIG. 2, on the side the manual feed tray 21 is located. The second stay 102 includes a vertical stay portion 102a extending in the vertical direction as a first stay portion and a horizontal stay portion 102b extending in the horizontal direction as a second stay portion. The horizontal stay portion 102b is formed to extend from the upper end of the vertical stay portion 102a and is bent at 90 degrees.

The second stay portion (e.g., 102) is fastened to each end of the pair of side plates (e.g., 110a, 110b) in the facing direction. The first stay portion (e.g., 102a) extends in a vertical direction perpendicular to the facing direction. The second stay portion (e.g., 102b) extends from an end of the first stay portion (e.g., 102a) in a horizontal direction perpendicular to the facing direction and the vertical direction. One of the pair of side plates (e.g., 110a, 110b) includes support portions (e.g., 111b, 111c) at both ends of a bottom thereof in the horizontal direction. The other of the pair of side plates (e.g., 110a, 110b) includes a support portion (e.g., 111a) at a center of a bottom thereof in the horizontal direction. The second screw hole (e.g., 112bl or 112b2) is larger than the first screw hole (e.g., 112al or 112a2).

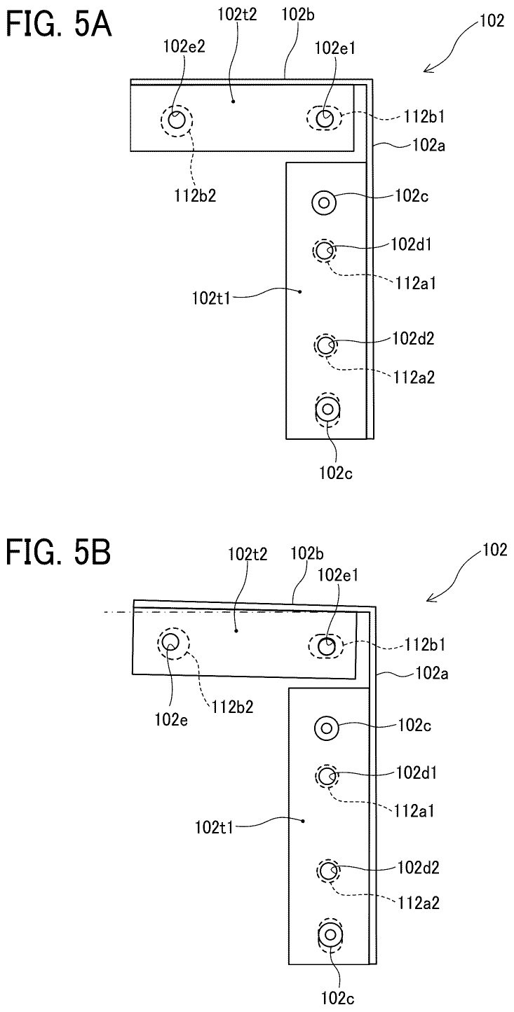

The vertical stay portion 102a includes vertical fastening portions 102t1 at both ends in a depth direction, which is the facing direction in which the pair of side plates 110a and 110b face each other (see FIG. 2). Each of the fastening portions 102t1 has two internal threads 102d1 and 102d2 as first internal threads (see FIGS. 5A and 5B). The horizontal stay portion 102b includes horizontal fastening portions 102t2 at its both ends in the depth direction in FIG. 2, each having two internal threads 102e1 and 102e2 as second internal threads (see FIGS. 5A and 5B). Further, each of the vertical fastening portions 102t1 in the vertical stay portion 102a includes positioning projections 102c (or positioners) at both its upper end and lower end. These positioning projections 102c engage with positioning holes formed in the side plates 110a and 110b. Thus, the second stay 102 is positioned relative to the side plates 110a and 110b.

The second stay 102 is fastened with screws 120 to the pair of side plates 110a and 110b by threading the screws 120 into the internal threads 102d1 and 102d2 of the vertical fastening portion 102t1 in the vertical stay portion 102a, and into the internal threads 102e1 and 102e2 of the horizontal fastening portion 102t2 in the horizontal stay portion 102b.

The first stay portion (e.g., 102a) has a positioner (e.g., 102c) to position the first stay portion (e.g., 102a) at the pair of side plates (e.g., 110a, 110b).

In the present embodiment, a positioner (e.g., the positioning projections 102c) is included in the first stay portion (e.g., the vertical stay portion 102a). However, this configuration is merely an example. In some examples, the positioner and the screw holes may be switched between the first stay portion and the second stay portion (e.g., the horizontal stay portion 102b), so that the positioner is included in the second stay portion instead.

The stay (e.g., 102) has a positioner (102c) to position the stay at the pair of side plates (e.g., 110a, 110b).

The third stay 103 is disposed below the second stay 102. The writing device 4 is positioned and supported by the third stay 103 and a base portion 106a of the sixth stay 106.

The fourth stay 104 is disposed below the third stay 103, extending from the left to the right side of the side plates 110a and 110b in FIG. 2. The fourth stay 104 serves as a sheet guide that guides sheets that is moving along the manual relay conveyance path 23 (see FIG. 1). The fourth stay 104 is fixed to the side plates 110a and 110b with screws 120 at four lateral positions.

The fifth stay 105 is screwed to the right side of the bottom of the side plates 110a and 110b in FIG. 2. The fifth stay 105 includes a horizontal stay portion 105a extending in the horizontal direction and an inclined stay portion 105b that is inclined relative to the vertical direction. The inclined stay portion 105b is formed by being bent relative to the right end of the horizontal stay portion 105a in FIG. 2. The horizontal stay portion 105a and the inclined stay portion 105b each are fixed with the screws 120 to the side plates 110a and 110b.

The sixth stay 106 is disposed above the fifth stay 105 and includes the base portion 106a that supports the writing device 4. The sixth stay 106 is fixed to each of the side plates 110a and 110b by screws 120 at two vertical positions.

The seventh stay 107 is disposed above the sixth stay 106 and includes a vertical stay portion 107a extending vertically and horizontal portions 107b horizontally extending from its ends in the depth direction in FIG. 2. The vertical stay portion 107a and the horizontal portions 107b are fixed to the side plates 110a and 110b with screws 120.

As shown in FIGS. 2 and 3, components and devices such as the image-forming units 7Y, 7C, 7M, and 7K, the sheet feeder 40, the fixing device 6, the bottle container 27, a toner supply device, a waste toner section, a drive device for driving, for example, the photoconductors, and an electrical board are mounted to the body frame 100. In recent years, to increase cost efficiency, efforts have been made to reduce the thickness of the side plates 110a and 110b and the first to seventh stays 101 to 107, to miniaturize the first to seventh stays 101 to 107, and to minimize their number.

In the present embodiment, the fourth stay 104 is used as a sheet guide that guides a sheet moving through the manual relay conveyance path 23, contributing to downsizing of the apparatus. However, due to the positional relationship with the manual relay conveyance path 23, the fourth stay 104 is not positioned alone to provide the desired strength for the body frame 100. In the present embodiment, the stays are placed at the four corners of the side plates in the vertical and horizontal directions within the layout constraints to achieve the desired strength of the body frame 100.

In the second stay 102, the vertical stay portion 102a and the horizontal stay portion 102b formed by bending the vertical stay portion 102a at a 90-degree angle enhance the stiffness of the second stay 102. The vertical stay portion 102a and the horizontal stay portion 102b are screwed to each of the side plate 110a and the side plate 110b. In the present embodiment, the stiffness of the second stay 102 is enhanced, and the vertical stay portion 102a and the horizontal stay portion 102b are fastened to each of the side plates. This configuration allows the first stay 101, the second stay 102, and fourth stay 104 to enable the strength of the left side of the body frame 100 in FIGS. 2 and 3.

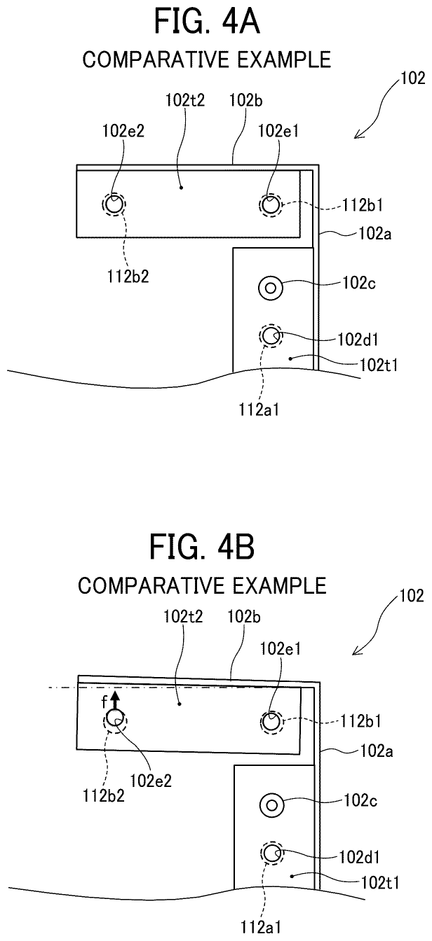

FIGS. 4A and 4B are diagrams each illustrating a configuration according to a comparative example, with aspects to be improved.

As illustrated in FIGS. 4A and 4B, the diameters of the two internal threads 102d1 and 102d2 in the vertical fastening portion 102t1 that fastens the vertical stay portion 102a of the second stay 102 to the side plate are equal to the diameters of the two internal threads 102e1 and 102e2 in the horizontal fastening portion 10212 that fastens the horizontal stay portion 102b to the side plate. The internal threads 102d1 and 102d2 of FIGS. 4A and 4B according to the comparative example correspond to the internal threads 102d1 and 102d2 of FIGS. 5A and 5B according to an embodiment. In the comparative example of FIGS. 4A and 4B, the diameters of screw holes 112al and 112a2 through which the screws 120 are threaded into the internal threads 102d1 and 102d2 of the vertical fastening portion 102t1 in each of the side plates 110a and 110b are equal to the diameters of screw holes 112b1 and 112b2 through which the screws 120 are threaded into the internal threads 102e1 and 102e2 of the horizontal fastening portion 102t2. The screw holes 112al and 112a2 of FIGS. 4A and 4B according to the comparative example correspond to the screw holes 112al and 112a2 of FIGS. 5A and 5B according to an embodiment. The diameters of the screw holes 112a1, 112a2, 112b1, and 112b2 in the side plates 110a and 110b are longer than the diameters of the internal threads 102d1, 102d2, 102e1, and 102e2 in the second stay 102. This configuration prevents the shanks of the screws 120 having substantially the same diameter as those of the internal threads 102d1, 102d2, 102e1, and 102e, from contacting the screw holes in the side plates 110a and 110b when the screws 120 are threaded into the internal threads of the second stay 102.

The perpendicularity of the horizontal stay portion 102b relative to the vertical stay portion 102a may deviate within the tolerance. Since the vertical stay portion 102a is positioned and attached to the side plates, any deviation in the perpendicularity causes a positional deviation of the horizontal stay portion 102b relative to the side plates. Specifically, as illustrated in FIG. 4B, among the two internal threads 102e1 and 102e2 in the horizontal fastening portion 102t2 that fastens the horizontal stay portion 102b to the side plates 110a and 110b, part of the internal thread 102e2 that is farther from the vertical stay portion 102a is positioned outside the screw hole 112b2 in the side plate. As a result of this configuration, when the screw 120 is threaded into the internal thread 102e2, the shank of screw 120 contacts the screw hole 112b2 in the side plates 110a and 110b, pressing the shank of the screw 120 in the direction of arrow f in FIG. 4B. This presses down the left side of the side plate to which the second stay 102 in FIG. 2 is fastened, in the vertical direction. Since the first side plate 110a on the front side in FIG. 2 is supported only by the rubber foot 111a located at the center of the bottom of the first side plate 110a in the right-to-left direction in FIG. 2, when the left side of the first side plate 110a in FIG. 2 is pressed downward in the vertical direction, the first side plate 110a may rotate, causing distortion in the body frame 100.

FIGS. 5A and 5B are diagrams each illustrating the screw holes 112a1, 112a2 as first screws, 112b1, and 112b2 as second screws in the side plates to which the second stay 102 is fastened with screws, according to an embodiment of the present disclosure.

In FIGS. 5A and 5B of the present embodiment, among the two screw holes 112bl and 112b2 in the side plate into which the screws 120 are inserted to fasten the horizontal stay portion 102b, the diameter of the screw hole 112b2 that is farther from the vertical stay portion 102a is longer than the diameters of the two screw holes 112al and 112a2 in the side plate into which the screws 120 are inserted to fasten the vertical stay portion 102a.

In the apparatus structure (e.g., 100), one of the pair of side plates (e.g., 110a, 110b) or the second stay portion (e.g., 102b) has multiple second screw holes (e.g., 112b1, 112b2) including the second screw hole. One of the multiple second screw holes (e.g., 112b1, 112b2) is disposed farthest from the first stay portion (e.g., 102a) fastened to the pair of side plates with the first screw; and is larger than the first screw hole (e.g., 112al or 112a2).

In some examples, one of the pair of side plates (e.g., 110a, 110b) or the first stay portion (e.g., 102a) has multiple first screw holes (e.g., 112a1, 112a2) including the first screw hole. One of the multiple first screw holes (e.g., 112a1, 112a2) is disposed farthest from the second stay portion (e.g., 102b) fastened to the pair of side plates with the second screw; and is larger than the second screw hole (e.g., 112b1 or 112b2).

This configuration allows the internal thread 102e2 farther from the vertical stay portion 102a, of the two internal threads 102e1 and 102e2 that fasten the horizontal stay portion 102b to the side plates, to be positioned within the screw hole 112b2 regardless of any deviation in the perpendicularity of the horizontal stay portion 102b relative to the vertical stay portion 102a within the tolerance. This prevents the shank of the screw 120 from contacting the screw hole 112b2 when the screw 120 is threaded into the internal thread 102e2. This further prevents the left side of the side plates in FIG. 2, to which the second stay 102 is fastened, from being pressed downward in the vertical direction, thus preventing distortion in the body frame 100.

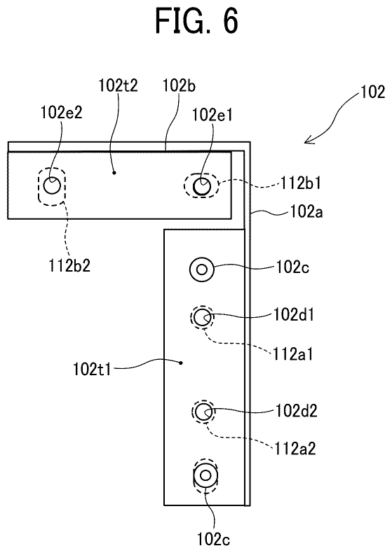

In FIGS. 5A and 5B, the screw hole 112b2 as one screw hole is a round hole. However, as illustrated in FIG. 6, the screw hole 112b2 may have an elongated shape, with its vertical length longer than the horizontal length. As illustrated in FIG. 6, both the vertical length and the horizontal length of the screw hole 112b2 are larger than the diameters of the screw holes 112al and 112a2 into which the screws 120 are inserted to fasten the vertical stay portion 102a. Since the misalignment of the internal thread 102e2 from its original position due to deviation in perpendicularity increases in the vertical direction, designing the screw hole 112b2 to be a vertically elongated hole effectively prevents the internal thread 102e2 from extending beyond the screw hole 112b2.

The second screw hole (e.g., 112bl or 112b2) has an elongated hole extending in the vertical direction. In some examples, the first screw hole (e.g., 112al or 112a2) has an elongated hole extending in the horizontal direction.

As illustrated in FIGS. 5A, 5B and 6, among the two screw holes 112b1 and 112b2 to which the screws 120 are inserted to fasten the horizontal stay portion 102b to the side plates, the screw hole 112b1 that is closer to the vertical stay portion 102a may be a horizontally elongated hole or round hole. It is preferable for the screw hole 112b1 that is closer to the vertical stay portion 102a to have a larger diameter than the screw holes 112al and 112a2 into which the screws 120 are inserted to fasten the vertical stay portion 102a. This prevents the internal thread 102e1 that is closer to the vertical stay portion 102a of the horizontal fastening portion 102t2, from extending beyond the screw hole 112b1 due to deviation in perpendicularity, and also prevents the shank of the screw 120 from contacting the screw hole 112b1.

In the present embodiment, the diameters of the screw holes 112b2 of both side plates are larger than the diameters of the screw holes 112al and 112a2. However, only the screw hole 112b2 of the first side plate 110a on the front side in FIG. 2, which is supported only by the rubber foot 111a located at the center of the bottom of the first side plate 110a in the right-to-left direction as illustrated in FIG. 2, may have a larger diameter than the screw holes 112al and 112a2. As described above, the second side plate 110b on the back side in FIG. 2 is supported on both ends of its bottom by the rubber feet 111b and 111c. This prevents the rotation of the second side plate 110b regardless of the force caused by the shanks of the screws 120 being pressed into the screw holes of the second side plate 110b in substantially the vertical direction. To also prevent the distortion of the body frame 100, only the screw hole 112b2 of the first side plate 110a at the front side in FIG. 2, which is supported only by rubber foot 111a located at the center of its bottom in the right-to-left direction as illustrated in FIG. 2, and is more likely to rotate when the shank of screw 120 is pressed into the screw hole in a substantially vertical direction, is designed to have a diameter larger than those of the screw holes 112al and 112a2.

Designing the screw holes 112b2 in both the first side plate 110a and the second side plate 110b to have larger diameters than those of the screw holes 112al and 112a2 offers the following advantages compared to designing only the screw hole 112b2 of the first plate 110a to have a diameter larger than those of the screw holes 112al and 112a2. When only the screw hole 112b2 of the first side plate 110a is designed to have a diameter larger than those of the screw holes 112al and 112a2, the back side of the horizontal stay portion 102b in FIG. 2 is deformed by the reaction force from any screw hole in the second side plate 110b, which is caused when the shank of the screw 120 is pressed into the screw hole, possibly resulting in twisting of the horizontal stay portion 102b. However, designing the screw holes 112b2 of both the first side plate 110a and the second side plate 110b to have larger diameters than those of the screw holes 112al and 112a2 prevents twisting of the horizontal stay portion 102b.

Unlike FIGS. 5A and 5B, in the case where the positioning projections 102c are included in the horizontal fastening portions 102t2 of the horizontal stay portions 102b, and the horizontal stay portion 102b is positioned on the side plates, the diameter of the screw hole 112a2, which is farther from the horizontal stay portion 102b and one of the two screw holes 112al and 112a2 in the side plate into which the screws 120 are inserted to fasten the vertical stay portion 102a, is made larger than those of the screw holes 112b1 and 112b2. The screw hole 112a2 is referred to as one screw hole. This configuration allows the internal thread 102d2 farther from the horizontal stay portion 102b, of the two internal threads 102d1 and 102d2 that fasten the vertical stay portion 102a to the side plates, to be positioned within the screw hole 112a2 regardless of any deviation in the perpendicularity of the horizontal stay portion 102b relative to the vertical stay portion 102a within the tolerance. This prevents the shank of the screw 120 from contacting the screw hole 112a2 when the screw 120 is threaded into the internal thread 102d2, and also prevents the side plate from being pressed in by the shank of the screw 120.

In the above description, the screw holes are included in the first side plate 110a and the second side plate 110b, and the internal threads are included in the vertical stay portion 102a and the horizontal stay portion 102b. However, in some examples, the internal threads are included in the first side plate 110a and the second side plate 110b, and the screw holes through which the screws are inserted are included in the vertical stay portion 102a and the horizontal stay portion 102b. However, it is preferable to include the screw holes in the first side plate 110a and the second side plate 110b and the internal threads in the vertical stay portion 102a and the horizontal stay portion 102b, because the screws can be threaded into the internal threads from the outside, and the assembly properties of the body frame 100 can be enhanced.

An apparatus structure (e.g., 100) includes a pair of side plates (e.g., 110a, 110b) facing each other in a facing direction; and a stay (e.g., 102) fastened to the pair of side plates (e.g., 110a, 110b) with a first screw and a second screw to connect the pair of side plates, the stay (e.g., 102) including a first stay portion (e.g., 102a); and a second stay portion (e.g., 102b) bent relative to the first stay portion (e.g., 102a). The pair of side plates (e.g., 110a, 110b) has a first screw hole (e.g., 112al or 112a2) through which the first screw is inserted. The first stay portion (102a) has a first internal thread (102d1 or 102d2) into which the first screw is threaded to fasten the first stay portion (102a) to the pair of side plates (110a, 110b) with the first screw. The pair of side plates (110a, 110b) has a second screw hole (112b1 or 112b2) through which the second screw is inserted. The second stay portion (102b) has a second internal thread (102e1 or 102e2) into which the second screw is threaded to fasten the second stay portion (102b) to the pair of side plates (110a, 110b) with the second screw. One of the first screw hole (112a1 or 112a2) or the second screw hole (112bl or 112b2) is larger than the other of the first screw hole (112a1 or 112a2) or the second screw hole (112b1 or 112b2).

In some examples, an apparatus structure (e.g., 100) includes a pair of side plates (e.g., 110a, 110b) facing each other in a facing direction; and a stay (e.g., 102) fastened to the pair of side plates (110a, 110b) with a first screw and a second screw to connect the pair of side plates, the stay (e.g., 102) including a first stay portion (e.g., 102a); and a second stay portion (e.g., 102b) bent relative to the first stay portion (e.g., 102a). The first stay portion (e.g., 102a) has a first screw hole (e.g., 112al or 112a2) through which the first screw is inserted. The pair of side plates (e.g., 110a, 110b) has a first internal thread (e.g., 102d1 or 102d2) into which the first screw is threaded to fasten the first stay portion (e.g., 102a) to the pair of side plates (e.g., 110a, 110b) with the first screw. The second stay portion (e.g., 102b) has a second screw hole (e.g., 112bl or 112b2) through which the second screw is inserted. The pair of side plates (e.g., 110a, 110b) having a second internal thread (e.g., 102e1 or 102c2) into which the second screw is threaded to fasten the second stay portion (e.g., 102b) to the pair of side plates (e.g., 110a, 110b) with the second screw. One of the first screw hole (e.g., 112al or 112a2) or the second screw hole (e.g., 112bl or 112b2) is larger than the other of the first screw hole (e.g., 112al or 112a2) or the second screw hole (e.g., 112bl or 112b2).

In the fifth stay 105 illustrated in FIGS. 2 and 3, if the angle of the inclined stay portion 105b relative to the horizontal stay portion 105a deviates from the target angle, any internal thread used to fasten the horizontal stay portion 105a of the fifth stay 105 or any internal thread used to fasten the inclined stay portion 105b may extend beyond the screw hole in the side plate. To deal with such a situation, it is preferable to make either screw holes in the side plates into which the screws 120 are inserted to fasten the horizontal stay portion 105a of the fifth stay 105, or screw holes in the side plates into which the screws 120 are inserted to fasten the inclined stay portion 105b of the fifth stay 105 larger than the other. This configuration prevents the side plate from being pressed in by the shank of the screw 120 used to fasten the fifth stay 105.

In the seventh stay 107 illustrated in FIGS. 2 and 3, a deviation in the perpendicularity of the horizontal portions 107b relative to the vertical stay portion 107a may cause internal threads used to fasten the vertical stay portion 107a of the seventh stay 107 or internal threads used to fasten the horizontal portions 107b to extend beyond screw holes in the side plates. To deal with such a situation, either screw holes in the side plates into which the screws 120 are inserted to fasten the vertical stay portion 107a of the seventh stay 107, or screw holes in the side plates into which the screws 120 are inserted to fasten the horizontal portions 107b of the seventh stay 107 may be made larger than the other. This configuration prevents the side plate from being pressed in by the shank of the screw 120 used to fasten the seventh stay 107.

Although the desirable embodiments and examples of the disclosure have been described above, the disclosure is not particularly limited to such specific embodiments and examples unless otherwise particularly limited in the above description, and various modifications and changes can be made without departing from the spirit and scope of the disclosure as set forth in the appended claims.

The configurations according to the above-descried embodiments are examples, and embodiments of the present disclosure are not limited to the above. For example, the following aspects can achieve effects described below.

### Aspect 1

An apparatus structure, such as a body frame 100, includes a pair of side plates 110a and 110b facing each other in a facing direction; a stay 102 fastened to the pair of side plates 110a and 110b with a screw 120 to connect the pair of side plates to each other; the stay 102 including a first stay portion (e.g., a vertical stay portion 102a in the present embodiment); and a second stay portion (e.g., a horizontal stay portion 102b in the present embodiment) bent relative to the first stay portion 102a. One (e.g., the pair of the side plates in the present embodiment) of the pair of side plates 110a and 110b or the first stay portion 102a has a first screw hole through which the screw 120 is inserted. The other (e.g., the vertical stay portion 102a in the present embodiment) has a first internal threads 102d1 or 102d2 into which the screw is threaded to fasten the first stay portion 102a to the pair of side plates 110a and 110b with the screw. One (e.g., the pair of side plates in the present embodiment) of the pair of side plates 110a and 110b or the second stay portion 102b has a second screw hole 112b1 through which the screw is inserted. The other (e.g., the horizontal stay portion 102b in the present embodiment) has a second internal thread 102e1 or 102e2 into which the screw 120 is threaded to fasten the second stay portion to the pair of side plates 110a and 110b with the screw. One (e.g., the second screw hole 112b2 in the present embodiment) of the first screw hole or the second screw hole is larger than the other (e.g., the first screw hole 112al or 112a2).

According to the first aspect, each of the first stay portion and the second stay portion is fastened to the pair of side plates with screws, and thus the pair of side plates can be firmly connected to each other. However, in the configuration that each of the first stay portion and the second stay portion is fastened to the pair of side plates, the following points were observed. The bending angle of the second stay portion relative to the first stay portion may deviate from the target angle. In this case, when one of the first stay portion and the second stay portion is fastened to the side plates, the bending angle deviation may cause a misalignment between the internal thread in one of the other stay portion and the side plates, and the screw hole in the other. In this case, if the sizes of the second screw holes and the first screw hole are the same, part of the internal thread for fastening the stay portions may extend beyond the corresponding screw hole. When the other stay portion is fastened to the side plate with screws, with part of the internal thread for fastening the stay portion extending beyond its corresponding screw hole for fastening the stay portion, the shank of the screw is pressed against the inner peripheral surface of the corresponding screw hole, and the resulting inward force causes distortion in the apparatus structure.

However, in the first aspect, making one of the first screw hole and the second screw hole larger than the other prevents part of one of the first internal thread and the second internal thread from extending beyond the one of the first screw hole and the second screw hole, even if the bending angle of the second stay portion relative to the first stay portion deviates and a screw is inserted through the other of the first screw hole and the second screw hole to fasten the other of the first stay portion and the second stay portion to the side plates. This prevents the screw shank fastened to the corresponding side plate from contacting and being pressed into the inner peripheral surface of the screw hole for fastening the stay portion, thus preventing the distortion of the apparatus structure.

### Aspect 2

According to Aspect 1, each of the pair of side plate 110a and 110b has the first screw hole 112al or 112a2 and the second screw hole 112b1 or 112b2.

This allows easier assembly of the apparatus structure, such as the body frame 100, than when each stay portion has screw holes, as described in the embodiments.

### Aspect 3

In Aspect 1 or 2, the one screw hole (the second screw hole (112b1 or 112b2) in the present embodiment) includes multiple screw holes. One of the multiple screw holes is farthest from the other stay portion (e.g., the vertical stay portion 102a in the present embodiment) that is fastened a screw inserted at least through the other screw hole (e.g., 112al or 112a2), and is larger than the first screw hole (e.g., 112al or 112a2).

Accordingly, as described in the embodiment, due to the deviation in the bending angle of the second stay portion, the internal threads (e.g., 112e1, 112e2 in the present embodiment) into which screws passing through one set of screw holes (in this embodiment, 112b1, 112b2) are threaded becomes misaligned from its original positions. Among these multiple internal threads, the one with the greatest misalignment is the internal thread 102e2, which is located farthest from the other stay portion, such as the vertical stay portion 102a. This causes the internal thread 102e2 located farthest from the other stay portion to easily extend beyond its corresponding screw hole. To deal with such a situation, the screw hole 112b2, which is one of the screw holes and located farthest from the first stay portion, is made larger than the screw holes 112al and 112a2 for the first stay portion. This prevents the shank of the screw 120 that successfully fastens one of the first stay portion and the second stay portion to the side plates 110a and 110b, from contacting the inner peripheral surface of the screw hole for the one of the first stay portion and the second stay portion. This effectively prevents the screw shank from being pressed into the inner spherical surface of one screw hole, thus preventing the distortion of the apparatus structure.

### Aspect 4

In any one of Aspect 1 to Aspect 3, the stay (e.g., the second stay 102) is fastened to an end of the pair of side plates 110a and 110b in a horizontal direction perpendicular to the facing direction, with the second stay portion (e.g., the horizontal stay portion 102b) extending in the horizontal direction from an end of the first stay portion (e.g., the vertical stay portion 102a) in a vertical direction perpendicular to the facing direction and the horizontal direction. One of the pair of side plates 110a and 110b includes support portions (e.g., rubber feet 111b, 111c) at both ends of its bottom in the horizontal direction, respectively. The other of the pair of side plates 110a and 110b includes a support portion (e.g., a rubber foot 111a) at the center portion of its bottom. The second screw hole is larger than the first screw hole.

In this configuration, as described above, the stay (e.g., the second stay 102) is fastened to an end of the pair of side plates 110a and 110b in the horizontal direction. This causes the inward force from the shank of the screw on the inner peripheral surface of the second screw hole for fastening the second stay portion in the side plates, generated by the bending angle deviation of the second stay portion (e.g., the horizontal stay portion 102b), to act as a rotational force that rotates the side plates. One side plate 110b, which is supported at both ends by the support portions, is prevented from rotating under the rotational force. However, the other side plate 110a, which is supported at its center by the support portion, is more likely to rotate under the rotational force, causing distortion in the apparatus structure such as the body frame 100.

To deal with such a situation, the second screw hole of the other side plate 110a supported at the center by the support portion is made larger than the first screw hole. This prevents the shank of the screw from being pressed into the second screw hole, and also prevents the occurrence of the rotational force on the other side plate. This effectively prevents distortion in the apparatus structures such as the body frame 100.

### Aspect 5

In any one of the first to fourth aspects, one (e.g., the screw hole 112b2) of the first screw hole (e.g., 112al or 112a2) or the second screw hole (e.g., 112bl or 112b2) has an elongated shape having a major diameter extending in a direction perpendicular to an extension direction in which one (e.g., the horizontal stay portion 102b) of the first stay portion or the second stay portion extends from the other (e.g., the vertical stay portion 102a) of the first stay portion or the second stay portion. The one of the first stay portion or the second stay portion is fastened with a screw 120, which is inserted through the one of the first screw hole (e.g., 112al or 112a2) or the second screw hole (e.g., 112bl or 112b2).

This configuration is designed to handle the situation that the misalignment of the internal thread 102e2, into which the screw is threaded to fasten one stay portion (e.g., the horizontal stay portion 102b), from its original position due to the deviation in the bending angle of the one stay portion increases in the direction perpendicular to the extension direction in which the one stay portion extends from the other stay portion (e.g., the vertical stay portion 102a). One screw hole has an elongated shape with a major diameter extending in the direction perpendicular to the extension direction in which one stay portion extends from the other stay portion. This successfully prevents one internal thread, into which a screw is threaded to fasten one stay portion from extending beyond one screw hole, which is caused by the bending angle deviation of the one stay portion. This effectively prevents the screw shank from being pressed into the inner spherical surface of one screw hole, thus preventing distortion of the apparatus structure.

### Aspect 6

In any one of the aspects 1 to 5, the other stay portion (e.g., the vertical stay portion 102a) has a positioner (e.g., a positioning projections 102c), the other stay portion being fastened with a corresponding screw of the first screw or the second screw, which is inserted through the other of the first screw hole (112a1 or 112a2) or the second screw hole (112b1 or 112b2).

In this configuration, the other stay portion (e.g., the vertical stay portion 102a) is fastened at a prescribed position on the side plate by the positioner (e.g., positioning projections 102c). This causes the internal thread in one stay portion to become misaligned due to bending angle deviation. To handle such a situation, one screw hole is made larger than the other screw hole, preventing part of the internal thread for fastening one stay portion from extending beyond the one screw hole.

### Aspect 7

An image forming apparatus 1 includes the apparatus structure (e.g., a body frame 100) according to any one of Aspect 1 to Aspect 4; and an image former in the apparatus structure to form an image.

This configuration prevents misalignment of image-formation related components and devices supported by the apparatus structure, such as the body frame 100, thus preventing degradation in image quality. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An apparatus structure comprising:
a pair of side plates facing each other in a facing direction; and
a stay fastened to the pair of side plates with a first screw and a second screw to connect the pair of side plates, the stay including:
a first stay portion; and
a second stay portion bent relative to the first stay portion,
one of the pair of side plates or the first stay portion having a first screw hole through which the first screw is inserted,
the other of the pair of side plates or the first stay portion having a first internal thread into which the first screw is threaded to fasten the first stay portion to the pair of side plates with the first screw,
one of the pair of side plates or the second stay portion having a second screw hole through which the second screw is inserted, and
the other of the pair of side plates or the second stay portion having a second internal thread into which the second screw is threaded to fasten the second stay portion to the pair of side plates with the second screw,
wherein one of the first screw hole or the second screw hole is larger than the other of the first screw hole or the second screw hole.

2. The apparatus structure according to claim 1,
wherein each of the pair of side plates has the first screw hole and the second screw hole.

3. The apparatus structure according to claim 1,
wherein the one of the pair of side plates or the second stay portion has multiple second screw holes including the second screw hole,
one of the multiple second screw holes is:
disposed farthest from the first stay portion fastened to the pair of side plates with the first screw; and
larger than the first screw hole.

4. The apparatus structure according to claim 1,
wherein the one of the pair of side plates or the first stay portion has multiple first screw holes including the first screw hole,
one of the multiple first screw holes is:
disposed farthest from the second stay portion fastened to the pair of side plates with the second screw; and
larger than the second screw hole.

5. The apparatus structure according to claim 1,
wherein the second stay is fastened to each end of the pair of side plates in the facing direction,
the first stay portion extends in a vertical direction perpendicular to the facing direction,
the second stay portion extends from an end of the first stay portion in a horizontal direction perpendicular to the facing direction and the vertical direction,
one of the pair of side plates includes support portions at both ends of a bottom thereof in the horizontal direction,
the other of the pair of side plates includes a support portion at a center of a bottom thereof in the horizontal direction, and
the second screw hole is larger than the first screw hole.

6. The apparatus structure according to claim 1,
wherein the first stay portion extends in a vertical direction perpendicular to the facing direction,
the second stay portion extends from an end of the first stay portion in a horizontal direction perpendicular to the facing direction and the vertical direction, and
the second screw hole has an elongated hole extending in the vertical direction.

7. The apparatus structure according to claim 1,
wherein the first stay portion extends in a vertical direction perpendicular to the facing direction,
the second stay portion extends from an end of the first stay portion in a horizontal direction perpendicular to the facing direction and the vertical direction, and
the first screw hole has an elongated hole extending in the horizontal direction.

8. The apparatus structure according to claim 1,
wherein the stay has a positioner to position the stay at the pair of side plates.

9. An image forming apparatus comprising:
the apparatus structure according to claim 1; and
an image former in the apparatus structure to form an image on a sheet.

10. An apparatus structure comprising:
a pair of side plates facing each other in a facing direction; and
a stay fastened to the pair of side plates with a first screw and a second screw to connect the pair of side plates, the stay including:
a first stay portion; and
a second stay portion bent relative to the first stay portion,
the pair of side plates having a first screw hole through which the first screw is inserted,
the first stay portion having a first internal thread into which the first screw is threaded to fasten the first stay portion to the pair of side plates with the first screw,
the pair of side plates having a second screw hole through which the second screw is inserted, and
the second stay portion having a second internal thread into which the second screw is threaded to fasten the second stay portion to the pair of side plates with the second screw,
wherein one of the first screw hole or the second screw hole is larger than the other of the first screw hole or the second screw hole.

11. An apparatus structure comprising:
a pair of side plates facing each other in a facing direction; and
a stay fastened to the pair of side plates with a first screw and a second screw to connect the pair of side plates, the stay including:
a first stay portion; and
a second stay portion bent relative to the first stay portion,
the first stay portion having a first screw hole through which the first screw is inserted,
the pair of side plates having a first internal thread into which the first screw is threaded to fasten the first stay portion to the pair of side plates with the first screw,
the second stay portion having a second screw hole through which the second screw is inserted, and
the pair of side plates having a second internal thread into which the second screw is threaded to fasten the second stay portion to the pair of side plates with the second screw,
wherein one of the first screw hole or the second screw hole is larger than the other of the first screw hole or the second screw hole.
